(19) United States
(12) Patent Application Publication
(10) Pub. No.: US 2017/0227113 A1
(43) Pub. Date: Aug. 10, 2017

(54) TRANSMISSION FLUID CONDITIONING FOR ELECTRIFIED VEHICLES

(71) Applicant: FORD GLOBAL TECHNOLOGIES, LLC, Dearborn, MI (US)

(72) Inventors: Mark Douglas MALONE, Canton, MI (US); William Najib MANSUR, West Bloomfield, MI (US); Daniel Paul ROBERTS, Livonia, MI (US); Beth Ann DALRYMPLE, Livonia, MI (US)

(21) Appl. No.: 15/015,404

(22) Filed: Feb. 4, 2016

(51) Int. Cl. F16H 57/04; B60K 6/445; B60K 6/40

(52) U.S. Cl. CPC F16H 57/0413; B60K 6/40; B60K 6/445; B60Y 2200/92; B60Y 2306/03; Y10S 903/951

(57) ABSTRACT

An electrified vehicle according to an exemplary aspect of the present disclosure includes, among other things, a transmission and an electrically powered heating device configured to selectively warm a transmission fluid circulated inside the transmission.

### TECHNICAL FIELD

This disclosure relates to a vehicle system and method associated with an electrified vehicle. The vehicle system includes an electrically powered heating device configured to condition a transmission fluid of the electrified vehicle if certain vehicle conditions are met.

### BACKGROUND

The need to reduce automotive fuel consumption and emissions is well known. Therefore, vehicles are being developed that reduce reliance on internal combustion engines. Electrified vehicles are one type of vehicle being developed for this purpose. In general, electrified vehicles differ from conventional motor vehicles because they are selectively driven by one or more battery powered electric machines. Conventional motor vehicles, by contrast, rely exclusively on the internal combustion engine to drive the vehicle.

Electrified vehicles present unique thermal management challenges. For example, achieving desired thermal operating levels of various components of the electrified vehicle must be balanced against maximizing the fuel economy and/or electric range of the electrified vehicle.

### SUMMARY

An electrified vehicle according to an exemplary aspect of the present disclosure includes, among other things, a transmission and an electrically powered heating device configured to selectively warm a transmission fluid circulated inside the transmission.

In a further non-limiting embodiment of the foregoing electrified vehicle, the electrically powered heating device is in direct contact with the transmission fluid inside the transmission.

In a further non-limiting embodiment of either of the foregoing electrified vehicles, the electrically powered heating device includes a positive temperature coefficient (PTC) heater.

In a further non-limiting embodiment of any of the foregoing electrified vehicles, the electrically powered heating device includes an infrared heating device.

In a further non-limiting embodiment of any of the foregoing electrified vehicles, the electrically powered heating device includes a resistive heating device.

In a further non-limiting embodiment of any of the foregoing electrified vehicles, the electrically powered heating device includes a probe that extends into a sump of the transmission.

In a further non-limiting embodiment of any of the foregoing electrified vehicles, a control module is configured to selectively command actuation of the electrically powered heating device.

In a further non-limiting embodiment of any of the foregoing electrified vehicles, the electrically powered heating device is powered by grid power.

In a further non-limiting embodiment of any of the foregoing electrified vehicles, the electrically powered heating device is powered by a high voltage battery pack.

In a further non-limiting embodiment of any of the foregoing electrified vehicles, the electrically powered heating device is mounted through an opening in a transmission housing of the transmission.

In a further non-limiting embodiment of any of the foregoing electrified vehicles, the electrically powered heating device is mounted within an oil pan of the transmission.

In a further non-limiting embodiment of any of the foregoing electrified vehicles, the electrically powered heating device is integrated into transmission cooling lines that circulate the transmission fluid.

In a further non-limiting embodiment of any of the foregoing electrified vehicles, the electrically powered heating device is integrated into a transmission oil cooler associated with the transmission.

A method according to another exemplary aspect of the present disclosure includes, among other things, selectively powering an electrically powered heating device to generate heat and warming a transmission fluid of a transmission of an electrified vehicle with the heat generated by the electrically powered heating device.

In a further non-limiting embodiment of the foregoing method, the method includes, prior to the powering step, determining whether an upcoming drive cycle is expected within a predefined threshold amount of time.

In a further non-limiting embodiment of either of the foregoing methods, the powering step includes powering the electrically powered heating device using grid power during an on-plug condition of the electrified vehicle.

In a further non-limiting embodiment of any of the foregoing methods, the warming step includes electrically generating heat inside the transmission using the electrically powered heating device.

In a further non-limiting embodiment of any of the foregoing methods, the warming step is continued until a temperature of the transmission fluid is within a desired operating temperature range.

In a further non-limiting embodiment of any of the foregoing methods, the method includes warming the transmission fluid during an off-plug condition by powering the electrically powered heating device with a high voltage battery assembly.

In a further non-limiting embodiment of any of the foregoing methods, the method includes, prior to the powering step, determining whether the electrified vehicle is on-plug.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a vehicle system of an electrified vehicle.

FIGS. 3A and 3B illustrate a first exemplary mounting location for an electrically powered heating device configured to condition a transmission fluid.

FIG. 4 illustrates another exemplary mounting location of an electrically powered heating device configured to condition a transmission fluid.

FIG. 5 illustrates another exemplary mounting location for an electrically powered heating device configured to condition a transmission fluid.

FIG. 6 illustrates yet another exemplary mounting location of an electrically powered heating device configured to condition a transmission fluid.

FIG. 7 schematically illustrates a control strategy for selectively conditioning a transmission fluid of an electrified vehicle transmission.

### DETAILED DESCRIPTION

This disclosure describes a vehicle system and method for conditioning a transmission fluid of an electrified vehicle if certain vehicle conditions have been met. The vehicle system may include a transmission and one or more electrically powered heating devices configured to selectively warm the transmission fluid of the transmission. In some embodiments, the electrically powered heating device is mounted in direct contact with the transmission fluid that is circulated inside the transmission. Various mounting locations are contemplated for the electrically powered heating device. These and other features are described in greater detail in the following paragraphs of this detailed description.

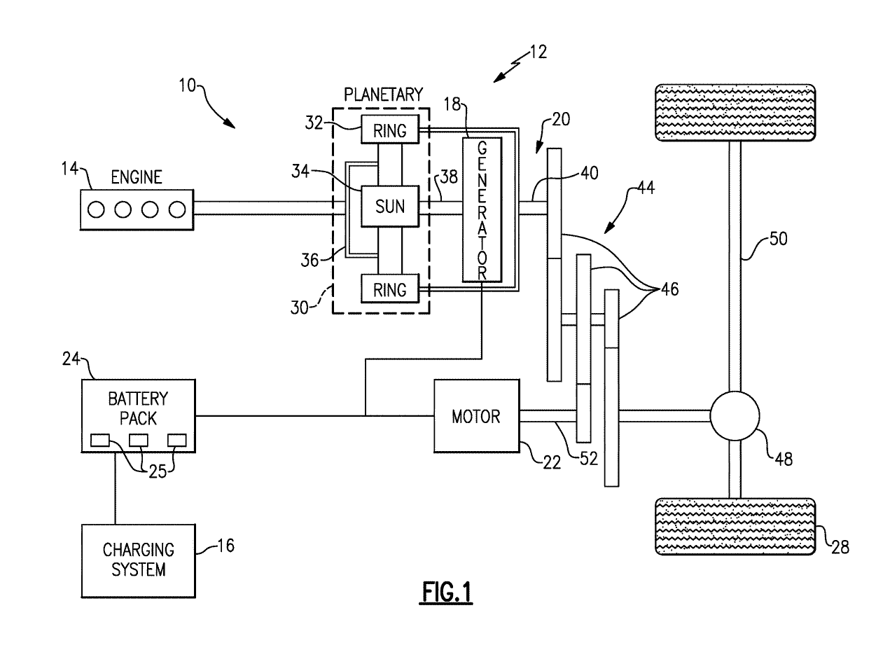

FIG. 1 schematically illustrates a powertrain 10 for an electrified vehicle 12. In one non-limiting embodiment, the electrified vehicle 12 is a plug-in hybrid electric vehicle (PHEV). However, other electrified vehicles could also benefit from the teachings of this disclosure, including but not limited to, battery electric vehicles (BEV's), hybrid electric vehicles (HEV's), 48V vehicles and 12V Stop-Start vehicles.

In one non-limiting embodiment, the powertrain 10 is a power-split powertrain system that employs a first drive system and a second drive system. The first drive system may include a combination of an engine 14 and a generator 18 (i.e., a first electric machine). The second drive system includes at least a motor 22 (i.e., a second electric machine) and a battery pack 24. In this example, the second drive system is considered an electric drive system of the powertrain 10. The first and second drive systems generate torque to drive one or more sets of vehicle drive wheels 28 of the electrified vehicle 12. Although a power-split configuration is shown, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28. In one embodiment, the power transfer units 30, 44 are part of a transaxle 20 of the electrified vehicle 12.

The motor 22 can also be employed to drive the vehicle drive wheels 28 by outputting torque to a shaft 52 that is also connected to the second power transfer unit 44. In one embodiment, the motor 22 is part of a regenerative braking system. For example, the motor 22 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22, the generator 18 and/or other electrical loads of the electrified vehicle 12. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

The electrified vehicle 12 may also include a charging system 16 for charging the energy storage devices (e.g., battery cells) of the battery pack 24. The charging system 16 may be connected to an external power source (e.g., electrical grid, not shown) for receiving and distributing power throughout the vehicle. The charging system 16 may also be equipped with power electronics used to convert AC power received from the external power supply to DC power for charging the energy storage devices of the battery pack 24. The charging system 16 may also accommodate one or more conventional voltage sources from the external power supply (e.g., 110 volt, 220 volt, etc.).

The powertrain 10 shown in FIG. 1 is highly schematic and is not intended to limit this disclosure. Various additional components could alternatively or additionally be employed by the powertrain 10 within the scope of this disclosure.

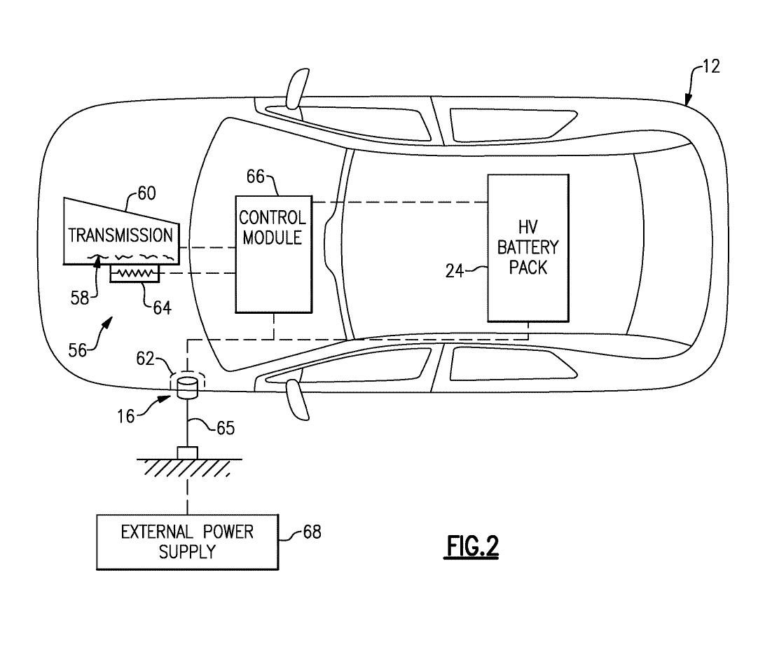

FIG. 2 is a highly schematic depiction of a vehicle system 56 that may be employed by an electrified vehicle, such as the electrified vehicle 12 of FIG. 1. The various components of the vehicle system 56 are shown schematically to better illustrate the features of this disclosure. These components, however, are not necessarily depicted in the exact locations where they would be found in an actual vehicle and are not necessarily shown to scale.

The vehicle system 56 is adapted to schedule and effectuate conditioning of a transmission fluid 58 of a transmission 60 of the electrified vehicle 12 either prior to a next expected usage time of the electrified vehicle 12 or during operation of the electrified vehicle 12. In one non-limiting embodiment, the transmission fluid 58 is warmed to achieve an optimal operating temperature range prior to the next expected usage time of the electrified vehicle 12. Conditioning the transmission fluid 58 during certain vehicle conditions may improve the fuel efficiency, durability, customer satisfaction and electric range of the electrified vehicle 12, among providing other potential benefits.

In one non-limiting embodiment, the exemplary vehicle system 56 includes the transmission 60, a high voltage battery pack 24, a charging system 16, one or more electrically powered heating devices 64 and a control module 66. The transmission 60 may be either an automatic transmission or a manual transmission. The transmission 60 circulates the transmission fluid 58, which has an optimal operating temperature range. Although not specifically shown by the highly schematic depiction of FIG. 2, the transmission 60 includes a series of gears, clutches, brakes, etc., and a transmission pump configured to circulate the transmission fluid 58 to lubricate the various components of the transmission 60 and/or maintain a desired pressure of the transmission fluid 58. The transmission 60 may additionally include a torque converter, although also not specifically shown.

The battery pack 24 may include one or more battery assemblies having a plurality of battery cells or other energy storage devices. The energy storage devices of the battery pack 24 store electrical energy that is selectively supplied to power various electrical loads residing on-board the electrified vehicle 12. These electrical loads may include various high voltage loads (e.g., electric machines, etc.) or various low voltage loads (e.g., lighting systems, low voltage batteries, logic circuitry, etc.).

The charging system 16 may include a charging port 62 located on the electrified vehicle 12 and a cordset 65 that is operably connectable between the charging port 62 and an external power source 68. The charging port 62 is adapted to selectively receive energy from the external power source 68, via the cordset 65, and then supply the energy to the battery pack 24 for charging the battery cells. In another non-limiting embodiment, the charging system 16 is a wireless charging system that wirelessly transfers power from the external power source 68 to the charging port 62. If necessary, the charging system 16 may convert alternating current received from the external power source 68 to direct current DC for charging the high voltage battery pack 24. The charging system 16 is also configured to establish maximum available charging currents for charging the battery pack 24, among other operational parameters. The external power source 68 includes off-board power, such as utility/grid power, in one non-limiting embodiment.

One or more electrically powered heating devices 64 (one shown in FIG. 2) are positioned relative to the transmission 60 of the electrified vehicle 12. The heating device 64 is configured to condition the transmission fluid 58 housed and circulated inside the transmission 60, such as by warming it. In one non-limiting embodiment, the heating device 64 is a positive temperature coefficient (PTC) heater positioned in direct contact with the transmission fluid 58. In another non-limiting embodiment, the heating device 64 is an infrared heating device configured to generate heat for warming the transmission fluid 58. In yet another non-limiting embodiment, the heating device 64 is a resistive heating device. The heating device 64 may be selected such that its maximum regulating temperature is within the optimal operating temperature range of the transmission fluid 58.

In one non-limiting embodiment, the heating device 64 is powered by grid power when the vehicle is “on-plug” (i.e., plugged into the external power source 68 when the vehicle is OFF). In another non-limiting embodiment, the heating device 64 is powered by the battery pack 24 when the vehicle is “off-plug” (i.e., unplugged from the external power source 68) or during operation of the electrified vehicle 12. In yet another non-limiting embodiment, the heating device 64 is powered by a self-contained energy storage device, such as a separate battery or special reserve power supply.

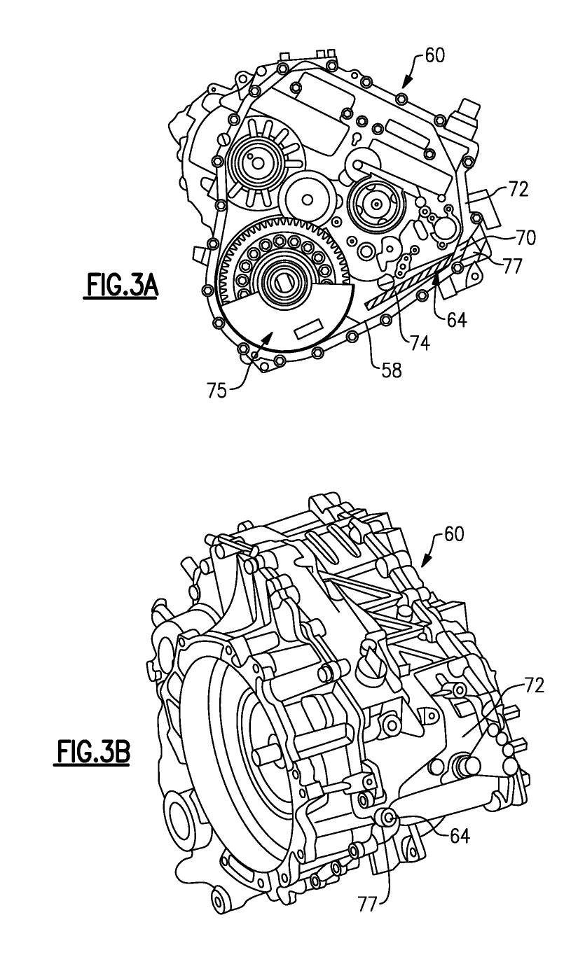

The heating device 64 may be mounted at various locations in relation to the transmission 60. For example, in a first non-limiting embodiment, shown in FIGS. 3A and 3B, the heating device 64 is inserted through a hole 70 in a transmission housing 72 of the transmission 60. A probe 74 of the heating device 64 may extend inside the transmission 60 such that it is in direct contact with the transmission fluid 58. For example, in one non-limiting embodiment, the probe 74 extends into a sump 75 of the transmission 60. A boss 77 marks the mounting location of the heating device 64 on the transmission housing 72.

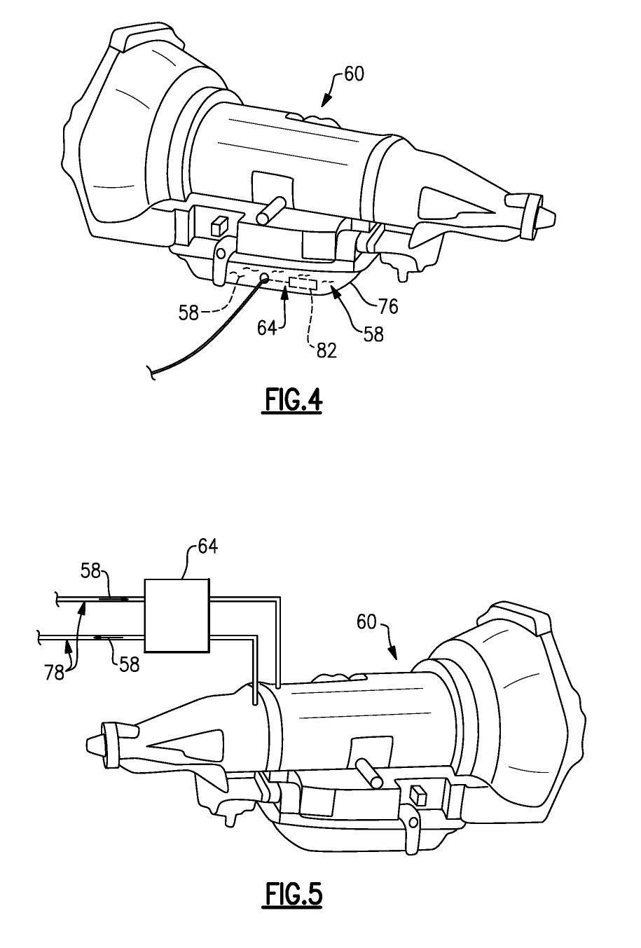

In another non-limiting embodiment, shown in FIG. 4, the heating device 64 is positioned within an oil pan 76 of a transmission 60. The heating device 64 of this embodiment may include a heater plate 82 that is mounted to a wall of the oil pan 76 such that it is in direct contact with the transmission fluid 58.

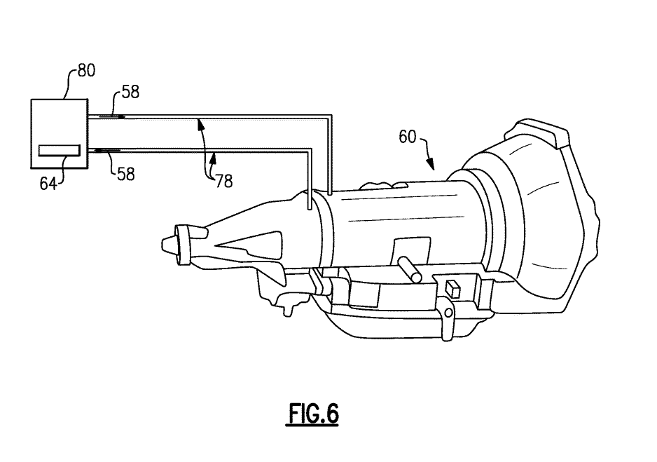

In another non-limiting embodiment, shown in FIG. 5, the heating device 64 is integrated into transmission cooling lines 78 that communicate the transmission fluid 58 to and from the transmission 60. For example, the transmission cooling lines 78 can be routed to extend through the heating device 64 for warming the transmission fluid 58 as it is communicated within the transmission cooling lines 78.

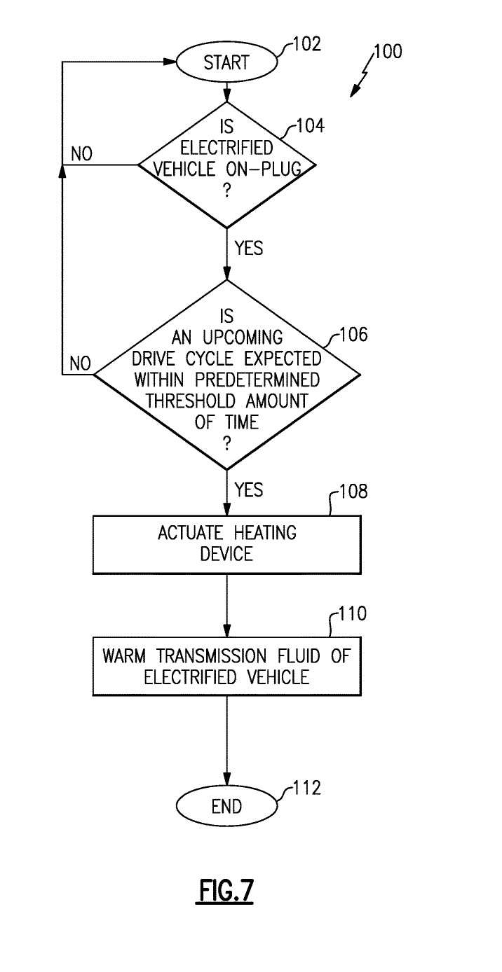

In yet another non-limiting embodiment, shown in FIG. 6, the heating device 64 is integrated into a transmission oil cooler 80 associated with the transmission 60. The transmission cooling lines 78 distribute the transmission fluid 58 to and from the transmission oil cooler 80. The heating device 64 can warm the transmission fluid 58 inside the transmission oil cooler 80 prior to delivering the transmission fluid 58 back to the transmission 60. Other mounting locations are also contemplated within the scope of this disclosure.

Referring again to FIG. 2, the control module 66 may be part of an overall vehicle control unit, such as a vehicle system controller (VSC), or could alternatively be a stand-alone control unit separate from the VSC. In one non-limiting embodiment, the control module 66 is part of a transmission control module (TCM) of the electrified vehicle 12. The control module 66 includes executable instructions for interfacing with and commanding operation of the various components of the vehicle system 56 including, but not limited to, the transmission 60, the battery pack 24, the charging system 16 and the heating device 64. The control module 66 may include multiple inputs and outputs for interfacing with the various components of the vehicle system 56. The control module 66 may additionally include a processing unit and non-transitory memory for executing the various control strategies and modes of the vehicle system 56.

In one non-limiting embodiment, the control module 66 is configured to actuate the heating device 64 to heat the transmission fluid 58. The control module 66 may command the heating device 64 ON when the electrified vehicle 12 is On-plug and an upcoming drive cycle is expected, in one non-limiting embodiment. In another non-limiting embodiment, the control module 66 is configured to determine when to start and stop conditioning the transmission 60 using the heating device 64. In yet another non-limiting embodiment, the control module 66 is configured to determine when the start and stop charging the battery pack 24 and determine the charging rate that should be used.

The control module 66 may additionally notify the driver/operator that the battery pack 24 has an insufficient SOC to warm the transmission fluid 58, can split the charge between the battery pack 24 and the heating device 64 based on customer preference and choice, can decide not to warm the transmission fluid 58 unless the battery pack 24 is fully charged, and can notify the driver/operator of the amount of time that will be necessary to warm up the transmission fluid 58. These are but several non-limiting examples of the many functions of the control module 66 of the vehicle system 56.

FIG. 7, with continued reference to FIGS. 1-6, schematically illustrates a control strategy 100 for controlling the vehicle system 56. For example, the control strategy 100 can be performed to warm the transmission fluid 58 of the electrified vehicle 12 if certain conditions have been met. The control module 66 can be programmed with one or more algorithms adapted to execute the control strategy 100, or any other control strategy. In one non-limiting embodiment, the control strategy 100 is stored as executable instructions in the non-transitory memory of the control module 66.

The control strategy 100 begins at block 102. At block 104, the control strategy 100 confirms whether or not the electrified vehicle 12 is on-plug. An on-plug condition of the electrified vehicle 12 exists when the electrified vehicle 12 is keyed OFF and the cordset 65 of the charging system 16 is plugged into both the charging port 62 and the external power source 68 and is capable of supplying power. If the electrified vehicle 12 is on-plug, the control strategy 100 may proceed to block 106.

Next, at block 106, the control strategy 100 determines whether an upcoming drive cycle is expected within a predefined threshold amount of time. In other words, the transmission fluid 58 is warmed only if it is expected that the owner/operator of the electrified vehicle 12 will soon remove the cordset 65 from the charging port 62 and begin a drive cycle (i.e., a Key-On event is likely to occur). The start time of the transmission fluid 58 conditioning may be a function of multiple factors. In one non-limiting embodiment, the start time of the transmission fluid 58 conditioning may be based, at least in part, on customer input. In another non-limiting embodiment, the start time of the conditioning may be based on the start time of a planned passenger cabin preconditioning. In yet another non-limiting embodiment, the start time of the conditioning may be based on an established pattern of drive cycles associated with the electrified vehicle 12. The start time of the conditioning may also be based at least partially on sensed conditions such as ambient temperatures and the temperature of the transmission fluid 58.

Logic for deriving the transmission fluid 58 conditioning start times may be programmed within the control module 66, such as within one or more look-up tables. By way of one non-limiting example, a first start time may be employed to begin warming the transmission fluid 58 if the upcoming drive cycle is expected in 15 minutes or less, whereas a second, later start time may be employed if the upcoming drive cycle is expected in greater than 15 minutes. This is only intended as one non-limiting example, and the predefined threshold amount of time may be set at any amount of time.

If it is determined at block 106 that an upcoming drive cycle is expected within the predefined threshold amount of time, the control strategy 100 may proceed to block 108 by actuating the heating device 64 to generate heat that is subsequently used to warm the transmission fluid 58. Other prompts may be monitored for initializing the heating device 64. Non-limiting examples of such prompts include actuation of a variety of touch points (e.g., keyfob, keypad, door ajar, etc.) or when a remote start sequence has been initiated.

Once the heating device 64 has been actuated at block 108, warming of the transmission fluid 58 begins at block 110. Conditioning, or warming, the transmission fluid 58 in this manner improves efficiencies by virtue of operating the transmission fluid 58 within its optimal operating temperature range. The transmission fluid 58 may be conditioned until the electrified vehicle 12 is taken off-plug or a vehicle start is initiated, at which point the control strategy 100 ends at block 112. If desired, the heating device 64 can be actuated during a drive cycle to heat the transmission fluid 58, such as by using power from the high voltage battery pack 24.

In another non-limiting embodiment, the transmission fluid 58 is warmed if the potential energy savings of warming the transmission fluid 58 is greater than the amount of energy required to warm the transmission fluid 58. The control module 66 is therefore configured to determine whether the potential energy savings of warming the transmission fluid 58 is greater than the amount of energy required to warm the transmission fluid 58. In one non-limiting embodiment, transmission efficiencies at various temperatures can be determined and logged into a lookup table. The control module 66 can then compare the Watt/hour efficiency of the vehicle with transmission fluid 58 warmup versus the optimized temperature efficiency minus energy used to warm the fluid. In another non-limiting embodiment, the decision of whether or not to warm the transmission fluid 58 is based on a driver's past driving history. For example, if the control module 66 knows that the driver is going to be making a short trip, it can decide not to warm the transmission fluid 58 and use the energy to propel the vehicle instead. The benefits of warming the transmission fluid 58 may not be realized during relatively short trips.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An electrified vehicle, comprising:
a transmission; and
an electrically powered heating device configured to selectively warm a transmission fluid circulated inside said transmission.

2. The electrified vehicle as recited in claim 1, wherein said electrically powered heating device is in direct contact with said transmission fluid inside said transmission.

3. The electrified vehicle as recited in claim 1, wherein said electrically powered heating device includes a positive temperature coefficient (PTC) heater.

4. The electrified vehicle as recited in claim 1, wherein said electrically powered heating device includes an infrared heating device.

5. The electrified vehicle as recited in claim 1, wherein said electrically powered heating device includes a resistive heating device.

6. The electrified vehicle as recited in claim 1, wherein said electrically powered heating device includes a probe that extends into a sump of said transmission.

7. The electrified vehicle as recited in claim 1, comprising a control module configured to selectively command actuation of said electrically powered heating device.

8. The electrified vehicle as recited in claim 1, wherein said electrically powered heating device is powered by grid power.

9. The electrified vehicle as recited in claim 1, wherein said electrically powered heating device is powered by a high voltage battery pack.

10. The electrified vehicle as recited in claim 1, wherein said electrically powered heating device is mounted through an opening in a transmission housing of said transmission.

11. The electrified vehicle as recited in claim 1, wherein said electrically powered heating device is mounted within an oil pan of said transmission.

12. The electrified vehicle as recited in claim 1, wherein said electrically powered heating device is integrated into transmission cooling lines that circulate said transmission fluid.

13. The electrified vehicle as recited in claim 1, wherein said electrically powered heating device is integrated into a transmission oil cooler associated with said transmission.

14. A method, comprising:
selectively powering an electrically powered heating device to generate heat; and
warming a transmission fluid of a transmission of an electrified vehicle with the heat generated by the electrically powered heating device.

15. The method as recited in claim 14, comprising, prior to the powering step, determining whether an upcoming drive cycle is expected within a predefined threshold amount of time.

16. The method as recited in claim 14, wherein the powering step includes powering the electrically powered heating device using grid power during an on-plug condition of the electrified vehicle.

17. The method as recited in claim 14, wherein the warming step includes electrically generating heat inside the transmission using the electrically powered heating device.

18. The method as recited in claim 14, wherein the warming step is continued until a temperature of the transmission fluid is within a desired operating temperature range.

19. The method as recited in claim 14, comprising warming the transmission fluid during an off-plug condition by powering the electrically powered heating device with a high voltage battery assembly.

20. The method as recited in claim 14, comprising, prior to the powering step, determining whether the electrified vehicle is on-plug.
